(19) United States
(12) Patent Application Publication
(10) Pub. No.: US 2026/0087450 A1
(43) Pub. Date: Mar. 26, 2026

(54) SERVER DEVICE, PROVISION METHOD, AND RECORDING MEDIUM

(71) Applicant: Rakuten Group, Inc., Tokyo (JP)

(72) Inventor: Hironao MATSUNAGA, Tokyo (JP)

(73) Assignee: Rakuten Group, Inc., Tokyo (JP)

(21) Appl. No.: 19/324,816

(22) Filed: Sep. 10, 2025

(30) Foreign Application Priority Data
Sep. 20, 2024 (JP) 2024-164465

(51) Int. Cl. G06Q 10/087

(52) U.S. Cl. CPC G06Q 10/08741

(57) ABSTRACT

In a server device, an intermittent appender intermittently appends to a report file for a store, at predetermined time intervals, log information of a record newly generated or updated in a database. Upon receiving a request for download of the report file from a store terminal, a supplementary appender appends to the report file the log information after the previous appending by the intermittent appender. Upon start of appending by the supplementary appender, a provider causes the intermittent appender to hold appending, and upon completion of the appending by the supplementary appender, provides the store terminal with the report file. Upon completion of providing the report file by the provider, a resumer initializes the report file, and then cancels holding of the intermittent appender to cause the intermittent appender to resume the appending.

### CROSS-REFERENCE TO RELATED APPLICATIONS

This application claims the benefit of Japanese Patent Application No. 2024-164465, filed on Sep. 20, 2024, the entire disclosure of which is incorporated by reference herein.

### FIELD OF THE INVENTION

The present disclosure relates to a server device, a provision method, and a recording medium.

### BACKGROUND OF THE INVENTION

In recent years, sales systems for conducting electronic commerce through the Internet have gained popularity. For example, a large-scale sales system formed by a collection of a large number of stores or virtual stores is used by a large number of users because not only the system handles products in a wide variety of categories or genres as a whole, but also there is price competition among the stores. In such a sales system, it is common to provide a logistics outsourcing service that performs logistics operations on behalf of a store. The logistics outsourcing service uses, for example, a logistics management system that is linked to the sales system to perform logistics operations of a store outsourcing the logistics operations. For example, the logistics management system performs, on behalf of the store, a series of logistics operations that includes managing each product handled by the store outsourcing the logistics operations in a dedicated warehouse, and when a user purchases the product handled by the store, picking the product from the warehouse, inspecting the product, and shipping the packed product to the user.

In order to ascertain the management status or the like of each product, a person in charge of the store outsourcing the logistics operations accesses the logistics management system and downloads a report file in which information or log information of the product is stored. This report file is generated by, for example, processing information read from a database of the logistics management system into a comma-separated values (CSV) format or the like. The information may be large depending on the number of products, sales conditions, and the like, and long time may be required to generate the report file. Therefore, when the report file is generated after receiving a request for download of the report file from the store, the download may not be completed due to a communication timeout.

As a related-art technique for reducing download time, for example, Japanese Patent Application Publication No. 2006-260212 discloses an invention of a server device or a file distribution server that allows download of a differential file to reduce download time.

However, the invention disclosed in Japanese Patent Application Publication No. 2006-260212 assumes that a client has already obtained a past version of the file, and cannot be applied to a case where a store outsourcing logistics operations downloads a report file for ascertaining the management status or the like of each product.

In view of such circumstances, there has been a demand for a technique capable of allowing quick download of a report file that requires a certain amount of time to be generated.

### SUMMARY OF THE INVENTION

The present disclosure is made in view of the above circumstances, and an objective of the present disclosure is to provide a server device, a provision method, and a recording medium capable of quickly providing a report file.

A server device according to a first aspect of the present disclosure includes:

an intermittent appender to intermittently append to a report file for a customer, at a predetermined time interval, log information of a record newly generated or updated in a database;

a supplementary appender to, upon receiving a request for download of the report file from a customer terminal used by the customer, append to the report file the log information after previous appending by the intermittent appender;

a provider to, upon start of appending by the supplementary appender, cause the intermittent appender to hold appending, and upon completion of the appending by the supplementary appender, provide the customer terminal with the report file; and

a resumer to, upon completion of providing the report file by the provider, initialize the report file, and then cancel holding of the intermittent appender to cause the intermittent appender to resume the appending.

In the server device according to the above aspect,

the intermittent appender may be configured to append to the report file the log information after the previous appending or the log information after previous supplementing by the supplementary appender.

In the server device according to the above aspect,

the intermittent appender and the supplementary appender may be configured to append the log information processed into a predetermined format to the report file.

In the server device according to the above aspect,

the resumer may be configured to cancel the holding of the intermittent appender to cause the intermittent appender to resume the appending after duplicating the report file as a history file and then initializing the report file, or after causing a newly-generated file with a different name to serve as the report file.

A provision method according to a second aspect of the present disclosure is a provision method to be executed by a server device, and the provision method includes:

an intermittent appending step of intermittently appending to a report file for a customer, at a predetermined time interval, log information of a record newly generated or updated in a database;

a supplementary appending step of, upon receiving a request for download of the report file from a customer terminal used by the customer, appending to the report file the log information after previous appending in the intermittent appending step;

a provision step of, upon start of appending in the supplementary appending step, holding appending in the intermittent appending step, and upon completion of the appending in the supplementary appending step, providing the customer terminal with the report file; and

a resuming step of, upon completion of providing the report file in the provision step, initializing the report file, and then canceling the holding to resume the appending in the intermittent appending step.

A recording medium according to a third aspect of the present disclosure is a non-transitory computer-readable recording medium storing a program, and the program causes a computer to perform operations including:

an intermittent appending step of intermittently appending to a report file for a customer, at a predetermined time interval, log information of a record newly generated or updated in a database;

a supplementary appending step of, upon receiving a request for download of the report file from a customer terminal used by the customer, appending to the report file the log information after previous appending in the intermittent appending step;

a provision step of, upon start of appending in the supplementary appending step, holding appending in the intermittent appending step, and upon completion of the appending in the supplementary appending step, providing the customer terminal with the report file; and

a resuming step of, upon completion of providing the report file in the provision step, initializing the report file, and then canceling the holding to resume the appending in the intermittent appending step.

The above information recording medium is a non-transitory recording medium and can be distributed and sold independently of the computer. Here, the non-transitory recording medium mentioned refers to a tangible recording medium. Examples of the non-transitory recording medium include compact disks, flexible disks, hard disks, magneto-optical disks, digital video disks, magnetic tapes, and semiconductor memory. A transitory recording medium refers to a transmission medium or a propagation signal itself. Examples of the transitory recording medium include electric signals, optical signals, and electromagnetic waves. A temporary storage area refers to an area for temporarily storing data or programs, for example, a volatile memory such as a random access memory (RAM).

### BRIEF DESCRIPTION OF DRAWINGS

FIG. 1 is a block diagram illustrating an exemplary overall configuration of a logistics management system according to the present embodiment;

FIG. 2 is a block diagram illustrating an overview of an exemplary configuration of a typical information processing device that implements a server device or the like according to the present embodiment;

FIG. 3 is a block diagram illustrating an exemplary functional configuration of the server device according to an embodiment;

FIG. 4 is a schematic diagram illustrating exemplary product management information stored in a database;

FIG. 5 is a schematic diagram illustrating exemplary log information;

FIG. 6 is a schematic diagram for describing timings of processing performed by an intermittent appender;

FIG. 7 is a schematic diagram for describing timings of processing performed by a supplementary appender;

FIG. 8 is a schematic diagram for describing a case where a download period overlaps a timing of processing performed by the intermittent appender;

FIG. 9A and 9B are both schematic diagrams for describing timings of processing resumed by the intermittent appender;

FIG. 10 is a flowchart for describing provision processing according to the embodiment; and

FIG. 11A and 11B are both schematic diagrams for describing timings of processing performed by an intermittent appender according to other embodiments.

### DETAILED DESCRIPTION OF THE INVENTION

Hereinafter, embodiments of the present disclosure are described. In the embodiments of the present disclosure, a configuration is described of downloading a report file storing log information to a store terminal from a logistics management system that performs logistics operations on behalf of a store, but this is merely an example. The present disclosure can be also applied to a configuration of downloading various files that requires a certain amount of time to be generated, as appropriate. That is, the following embodiments are intended only for description and are not intended to limit the scope of the present disclosure. Accordingly, it is possible for persons skilled in the art to employ an embodiment in which part or all of the elements of the embodiments are replaced by equivalents thereof, which are also included in the scope of the present disclosure.

### OVERALL CONFIGURATION

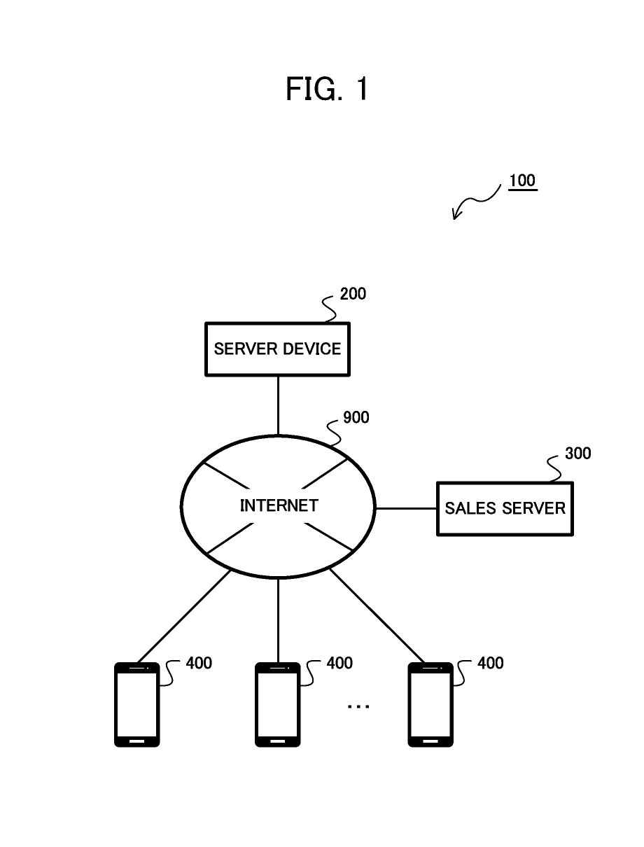

As illustrated in FIG. 1, a logistics management system 100 according to the embodiments of the present disclosure includes a server device 200, a sales server 300, and store terminals 400. The server device 200, the sales server 300, and the store terminals 400 are communicably connected to one another via the Internet 900 that is an example of a network. FIG. 1 illustrates only a few store terminals 400 to facilitate understanding of the present disclosure. In reality, a large number of store terminals 400 are included in the logistics management system 100 corresponding to the number of stores outsourcing logistics operations to the logistics management system 100.

The server device 200 is implemented as, for example, a computer for a server, and performs logistics operations on behalf of the stores outsourcing the logistics operations. As one example, the server device 200 manages products of the stores outsourcing the logistics operations in a warehouse of an operator that provides a logistics outsourcing service. The server device 200 is configured to be communicable to a non-illustrated warehouse terminal used by a worker in the warehouse and a non-illustrated deliverer terminal used by a deliverer. The server device 200 performs a series of logistics operations including managing, in the warehouse, products handled by the stores outsourcing the logistics operations, and when a user purchases one of the products of the stores on the sales server 300, instructing the worker via the warehouse terminal to pick the product from the warehouse, inspect the product, and ship the packed product to the user. The server device 200 intermittently appends, to the report file, log information of operations handling the managed products and the like. Upon receiving a request for download of the report file from the store terminal 400, the server device 200 provides the store terminal 400 with, that is, causes the store terminal 400 to download, the report file supplemented with the log information that has been updated after the most recent timing of appending.

The sales server 300 is implemented as, for example, a computer for a server, and manages a sales site for selling products. As one example, the sales server 300 also handles the products of the stores outsourcing the logistics operations, and when a user purchases one of the products of the stores, transmits outbound and shipping information of the product to the server device 200.

The store terminals 400 are implemented as, for example, smartphones, tablet computers, personal computers (PCs), or the like, and are used by the stores outsourcing the logistics operations. As one example, the store terminals 400 access the server device 200 to request download of the report file, and download the report file provided in response to the request.

### OVERVIEW OF CONFIGURATION OF INFORMATION PROCESSING DEVICE

A typical information processing device 500 that implements the server device 200 or the like according to the present embodiment is described below.

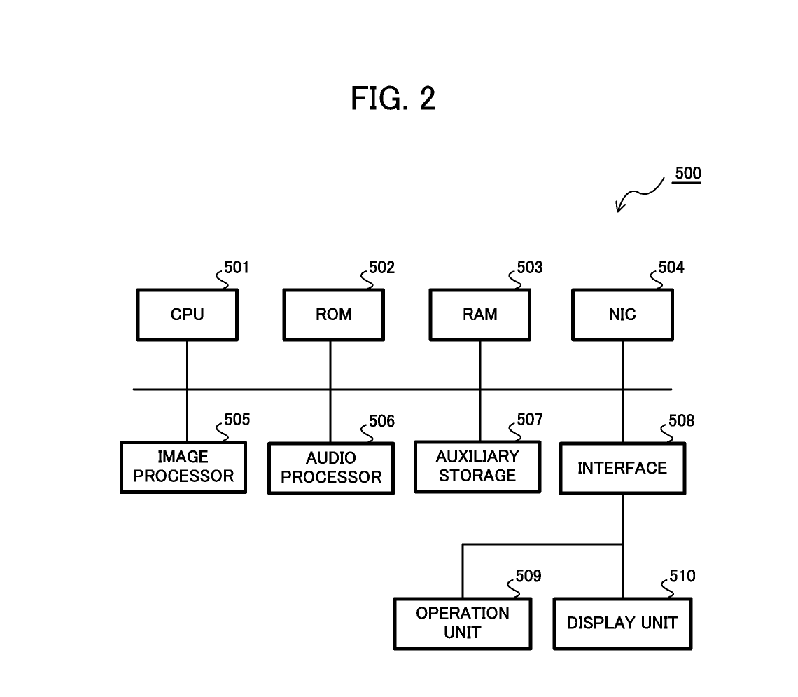

As illustrated in FIG. 2, the information processing device 500 includes a central processing unit (CPU) 501, a read only memory (ROM) 502, a random access memory (RAM) 503, a network interface card (NIC) 504, an image processor 505, an audio processor 506, an auxiliary storage 507, an interface 508, an operation unit 509, and a display unit 510.

The CPU 501 controls operations of the entire information processing device 500, is connected to the other components, and exchanges control signals and data with the other components.

The ROM 502 stores an initial program loader (IPL) that runs immediately after the power is turned on, and when the IPL runs, reads a program stored in the auxiliary storage 507 on the RAM 503, and the CPU 501 starts to execute the program.

The RAM 503 is intended to temporarily store data or a program, and retains the program or data read from the auxiliary storage 507 and other data necessary for communication.

The NIC 504 is intended to connect the information processing device 500 to a computer communication network such as the Internet. The NIC 404 includes an NIC conforming to a 10BASE-T/100BASE-T standard for use in configuring a local area network (LAN), an analog modem for connection to the Internet using a telephone line, an integrated services digital network (ISDN) modem, an asymmetric digital subscriber line (ADSL) modem, a cable modem for connection to the Internet using a cable television line, and the like.

The image processor 505 processes image data read from the auxiliary storage 507 or the like by using the CPU 501 or a non-illustrated image arithmetic processor included in the image processor 505, and then stores the image data in a non-illustrated frame memory included in the image processor 505. The image information stored in the frame memory is converted to a video signal at a predetermined synchronization timing, and is output to the display unit 510 via the interface 508 or the like. That is, under the control of the CPU 501, the image processor 505 generates an image necessary for the progression of processing performed by the information processing device 500, and displays the image on the display unit 510.

The audio processor 506 converts audio data read from the auxiliary storage 507 or the like to an audio signal, and outputs the audio signal to, for example, an external speaker. That is, under the control of the CPU 501, the audio processor 506 generates an audio to be emitted in the progression of the processing performed by the information processing device 500, and causes the speaker to output the audio.

The secondary storage 507 is implemented as a hard disk or the like, and stores various programs or various types of data necessary for control of the operations of the entire information processing device 500. For example, the auxiliary storage 507 stores programs for implementing the server device 200 or the like according to the present embodiment. The secondary storage 507 reads the stored programs or data by control of the CPU 501 as appropriate, and causes the RAM 503 or the like to temporarily store the programs or data.

The interface 508 is connected to the operation unit 509 and the display unit 510. The interface 508 may exchange necessary information with other external devices connected thereto.

The operation unit 509 accepts an operation input from the worker or the like using the information processing device 500.

The display unit 510 draws an image corresponding to the image data output by the image processor 505, and presents the image to the worker or the like using the information processing device 500.

In addition, the information processing device 500 may include a drive unit such as a digital versatile disc (DVD)-ROM, instead of the auxiliary storage 507. In this configuration, the information processing device 500 reads a program or data from the DVD-ROM or the like mounted on the drive unit, and operates in the same manner as described above.

### EMBODIMENT

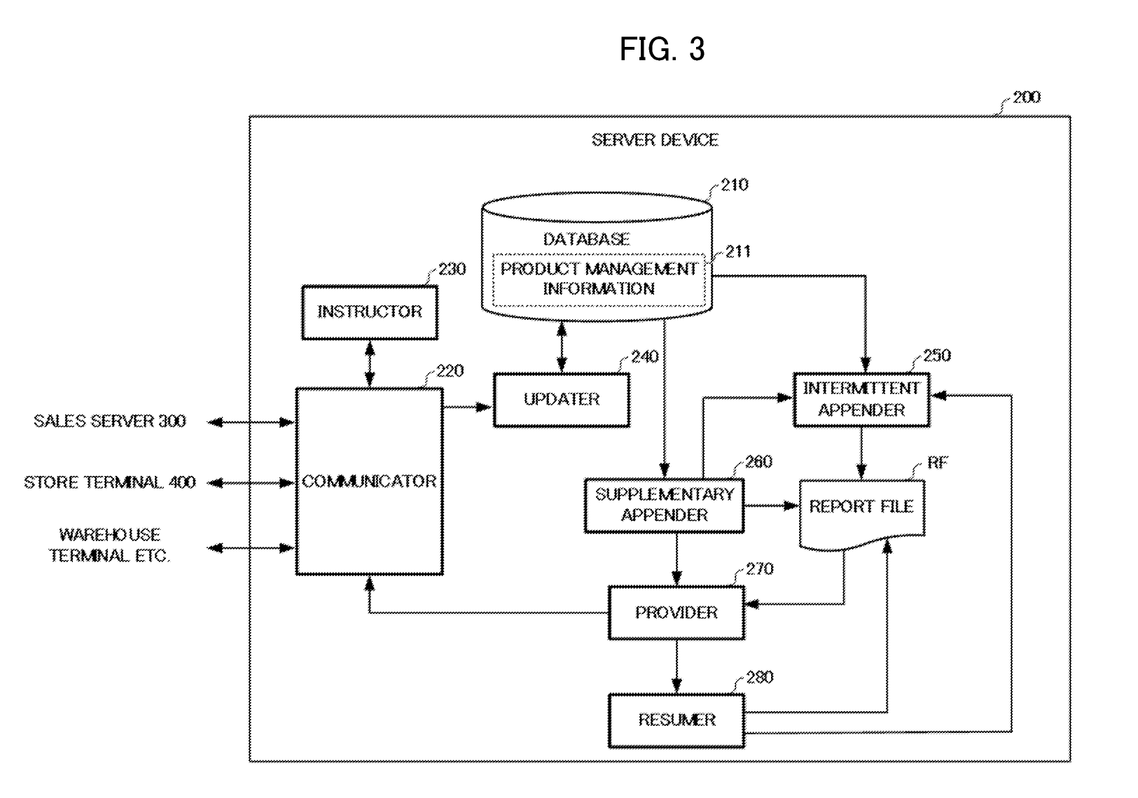

Hereinafter, the server device 200 according to the embodiment is described with reference to FIGS. 3 to 9. The server device 200 is implemented by the above information processing device 500. For example, when the power of the information processing device 500 is turned on, a program causing the information processing device 500 to function as the server device 200 is executed, and the server device 200 according to the present embodiment is implemented.

### FUNCTIONAL CONFIGURATION OF SERVER DEVICE

FIG. 3 is a block diagram illustrating an exemplary functional configuration of the server device 200 according to the embodiment. As illustrated in FIG. 3, the server device 200 includes a database 210, a communicator 220, an instructor 230, an updater 240, an intermittent appender 250, a supplementary appender 260, a provider 270, and a resumer 280.

The database 210 stores various types of information necessary for operation of the logistics management system 100 in an updatable manner. For example, the database 210 stores product management information 211 for managing the products outsourced by each of the stores.

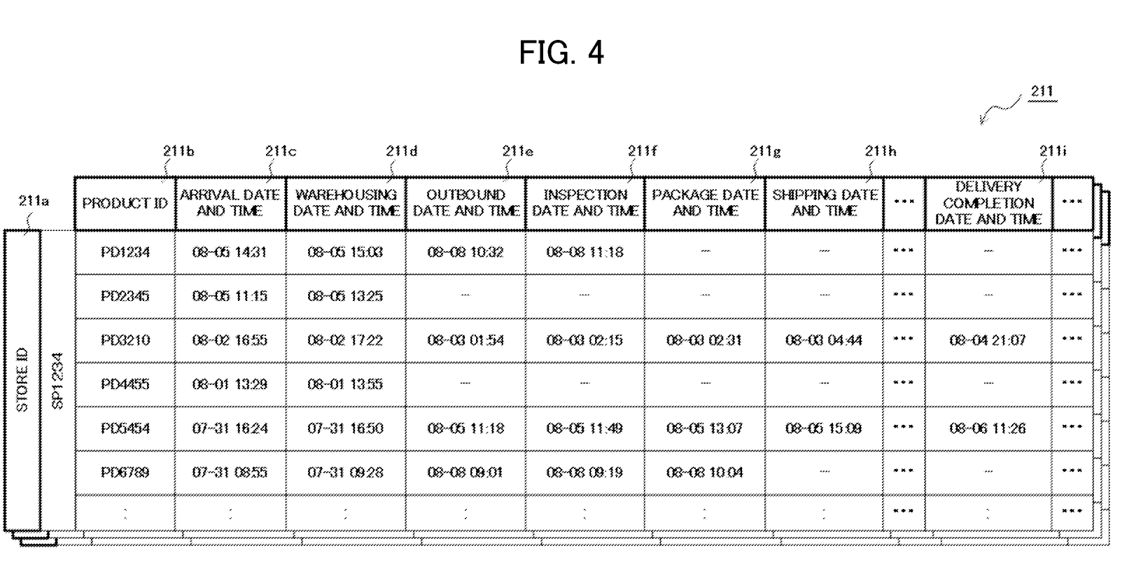

Specifically, the database 210 stores the product management information 211 as illustrated in FIG. 4. As one example, this product management information 211 includes a store identification (ID) 211a, product IDs 211b, arrival dates and times 211c, warehousing dates and times 211d, picking dates and times 211e, inspection dates and times 211f, package dates and times 211g, shipping dates and times 211h, and delivery completion dates and times 211i. That is, it is possible to manage each of the products from arrival or receipt thereof to completion of delivery thereof for each of store IDs of the stores outsourcing the logistics operations. Each of records in the product management information 211, that is, each of the product IDs 211b to the delivery completion dates and times 211i includes, for example, non-illustrated update management information to allow grasp of a generation date and time of the record and the last update date and time of the records.

In addition, the database 210 also stores store information that is related to each of the stores outsourcing the logistics operations, such as a store name, an address, and contact information, product information that is information of each of the outsourced products, such as a product name, a size, and a weight, and web page information for providing the store with the report file, such as a login ID, a password, and a data address.

The above auxiliary storage 507 can function as the database 210 as described above.

Returning to FIG. 3, the communicator 220 exchanges various types of information with the sales server 300, the store terminals 400, and the warehouse terminal that includes the deliverer terminal and the like. For example, when a product of one of the stores outsourcing the logistics operations has arrived and warehousing thereof has been completed, the communicator 220 transmits warehousing information of the product to the sales server 300. Upon receiving this warehousing information, the sales server 300 generates a new product page in the store or increases the inventory count on an existing product page to enable sale of the product. When a customer purchases a product of one of the stores outsourcing the logistics operations on the sales server 300, the communicator 220 receives the outbound and shipping information of the product transmitted from the sales server 300. The communicator 220 also receives the request for download of the report file from the store terminal 400. The communicator 220 then cooperates with the provider 270 described later to provide the store terminal 400 with the report file, that is, cause the store terminal 400 to download the report file. In addition, the communicator 220 transmits, to the warehouse terminal, an instruction such as a picking instruction, an inspection instruction, a package instruction, or a shipping instruction, and receives, from the warehouse terminal, operation information of the product such as arrival completion, warehousing completion, picking completion, inspection completion, package completion, and shipping completion.

The above NIC 504 or the like can function as the communicator 220 as described above.

The instructor 230 instructs the worker in the warehouse through the warehouse terminal to perform various operations handling the product. For example, when the communicator 220 receives the outbound and shipping information of the product transmitted from the sales server 300, the instructor 230 transmits a picking instruction of the product to the warehouse terminal. When the communicator 220 receives a notification of picking completion transmitted from the warehouse terminal, the instructor 230 transmits an inspection instruction of the product to the warehouse terminal. In the same manner, the instructor 230 transmits a package instruction, a shipping instruction, and the like to the warehouse terminal.

The above CPU 501 can function as the instructor 230 as described above.

The updater 240 updates the database 210 in accordance with the status of each of the operations handling the product. That is, the updater 240 updates each of the above records in the product management information 211 illustrated in FIG. 4, that is, each of the product IDs 211b to the delivery completion dates and times 211i in accordance with the operation information transmitted from the warehouse terminal. For example, when the communicator 220 receives a notification of arrival completion transmitted from the warehouse terminal, the updater 240 generates new records associated with the store ID 211a to update the corresponding product ID 211b and arrival date and time 211c. When the communicator 220 receives a notification of warehousing completion transmitted from the warehouse terminal, the updater 240 updates the corresponding warehousing date and time 211d. In the same manner, the updater 240 updates each of the corresponding picking date and time 211e, inspection date and time 211f, package date and time 211g, and shipping date and time 211h in accordance with the operation information such as picking completion, inspection completion, package completion, or shipping completion. Furthermore, when the communicator 220 receives a notification of delivery completion transmitted from the deliverer terminal, the updater 240 updates the corresponding delivery completion date and time 211i.

The above CPU 501 can function as the updater 240 as described above.

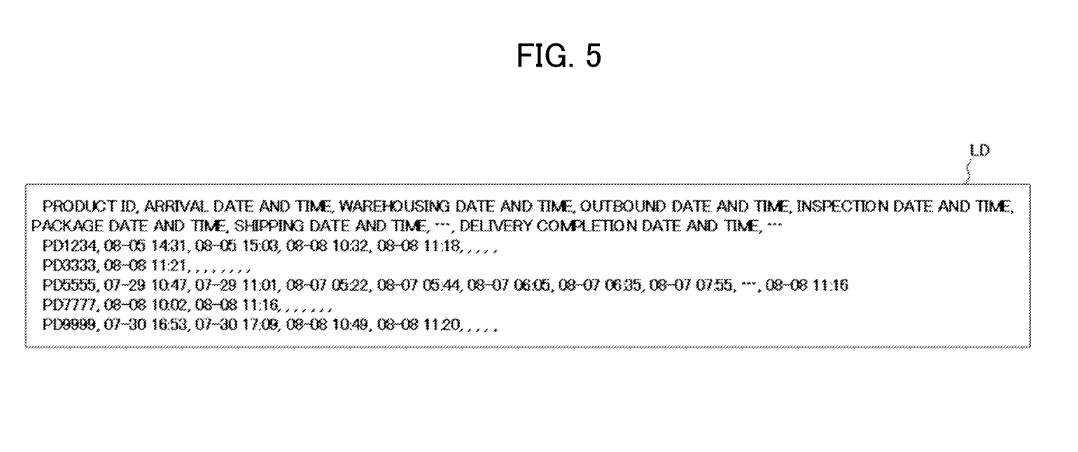

The intermittent appender 250 intermittently appends, to a report file RF for each of the stores outsourcing the logistics operations, at predetermined time intervals, log information of a record newly generated or updated by the database 210. For example, each time a timing of appending arrives, the intermittent appender 250 searches for a record newly generated or updated after the previous timing of appending among the records associated with the store ID 211a in the product management information 211, and appends the log information of the searched record to the report file RF. The intermittent appender 250 searches for a record with date and time information after the previous timing of appending, such as arrival date and time, warehousing date and time, outbound date and time, inspection date and time, package date and time, shipping date and time, or delivery completion date and time. The intermittent appender 250 also searches for a record generated after the previous timing of appending. Specifically, the intermittent appender 250 appends log information LD as illustrated in FIG. 5 to the report file RF. FIG. 5 illustrates the log information LD processed into a CSV format, but this is merely an example. The log information LD appended to the report file RF may be that processed into a JavaScript® object notation (JSON) format, an extensible markup language (XML) format, or the like. That is, the log information LD is not limited to that in a CSV format, and may be data in other formats as long as the data indicates the searched record.

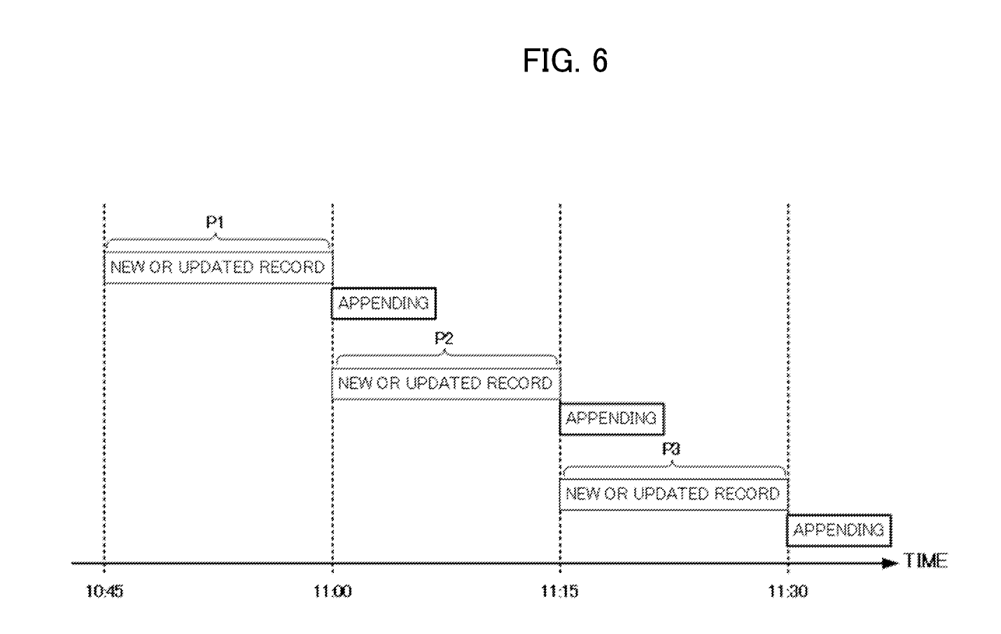

The timings of appending by the intermittent appender 250 are described in detail with reference to FIG. 6. As one example, FIG. 6 illustrates a configuration in which each of the timings of appending arrives at 15-minute intervals. As illustrated in FIG. 6, first at 11:00, the intermittent appender 250 appends to the report file RF the log information of a record newly generated or updated during a period P1 from 10:45 to 11:00, more precisely, 10:45.00 to 10:59.99. Next, at 11:15, the intermittent appender 250 appends to the report file RF the log information of a record newly generated or updated during a period P2 from 11:00 to 11:15. Next, at 11:30, the intermittent appender 250 appends to the report file RF the log information of a record newly generated or updated during a period P3 from 11:15 to 11:30. As described above, each time the timing of appending arrives, the intermittent appender 250 appends to the report file RF a record newly generated or updated after the previous timing of appending.

The above CPU 501 can function as the intermittent appender 250 as described above.

Returning to FIG. 3, upon receiving the request for download of the report file from the store terminal 400, the supplementary appender 260 appends to the report file RF the log information after the previous timing of appending. For example, in response to the request for download, the supplementary appender 260 searches for a record newly generated or updated after the previous timing of appending by the intermittent appender 250 among the records associated with the store ID 211a in the product management information 211, and appends the log information of the searched record to the report file RF. At this time, also the supplementary appender 260 appends to the report file RF the above log information LD processed into the CSV format as illustrated in FIG. 5. In a configuration in which the intermittent appender 250 appends to the report file RF the log information LD processed into a JSON format or the like, also the supplementary appender 260 appends to the report file RF the log information LD processed into the same JSON format or the like.

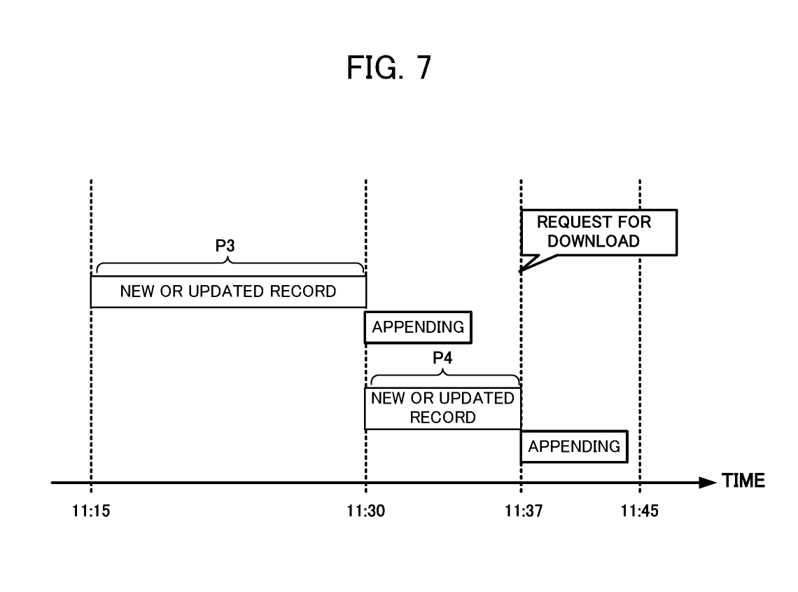

The timings of appending by the supplementary appender 260 are described in detail with reference to FIG. 7. As illustrated in FIG. 7, upon receiving the request for download from the store terminal 400 at 11:37 after the intermittent appender 250 has appended the log information of the period P3, which is 11:15 to 11:30, to the report file RF at 11:30, the supplementary appender 260 appends to the report file RF the log information of a record newly generated or updated during a period P4 from 11:30 to 11:37.

The above CPU 501 can function as the supplementary appender 260 as described above.

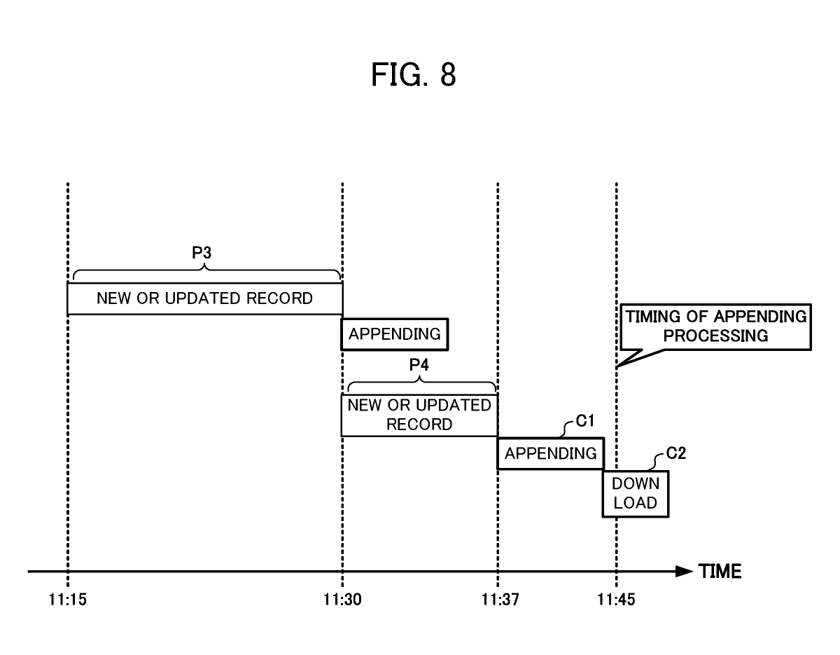

Returning to FIG. 3, the provider 270, upon start of appending by the above supplementary appender 260, causes the intermittent appender 250 to hold appending, and upon completion of the appending by the supplementary appender 260, provides the store terminal 400 with the report file RF, that is, causes the store terminal 400 to download the report file RF. For example, as illustrated in FIG. 8, appending C1 by the supplementary appender 260 and download C2 by the store terminal 400 take a certain amount of time, and the timing of appending by the intermittent appender 250 may arrive at 11:45 during the download C2. Therefore, the provider 270 causes the intermittent appender 250 to hold the appending so as not to perform the appending even when the timing of appending arrives.

The above CPU 501 can function as the provider 270 as described above.

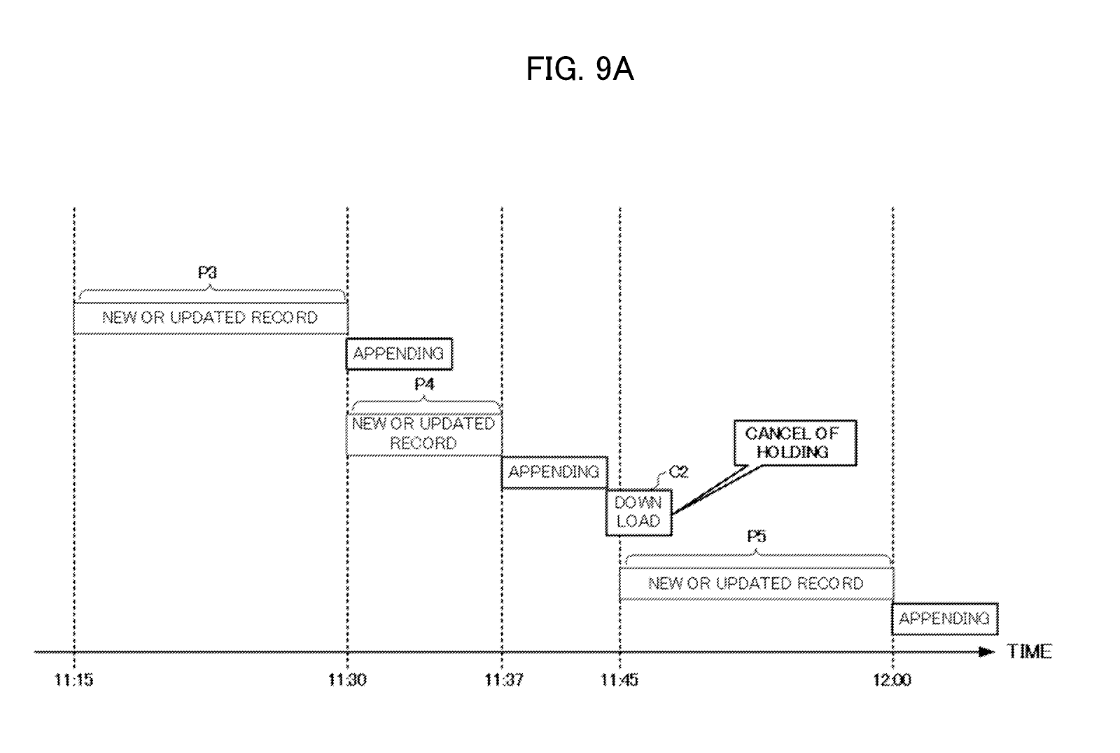

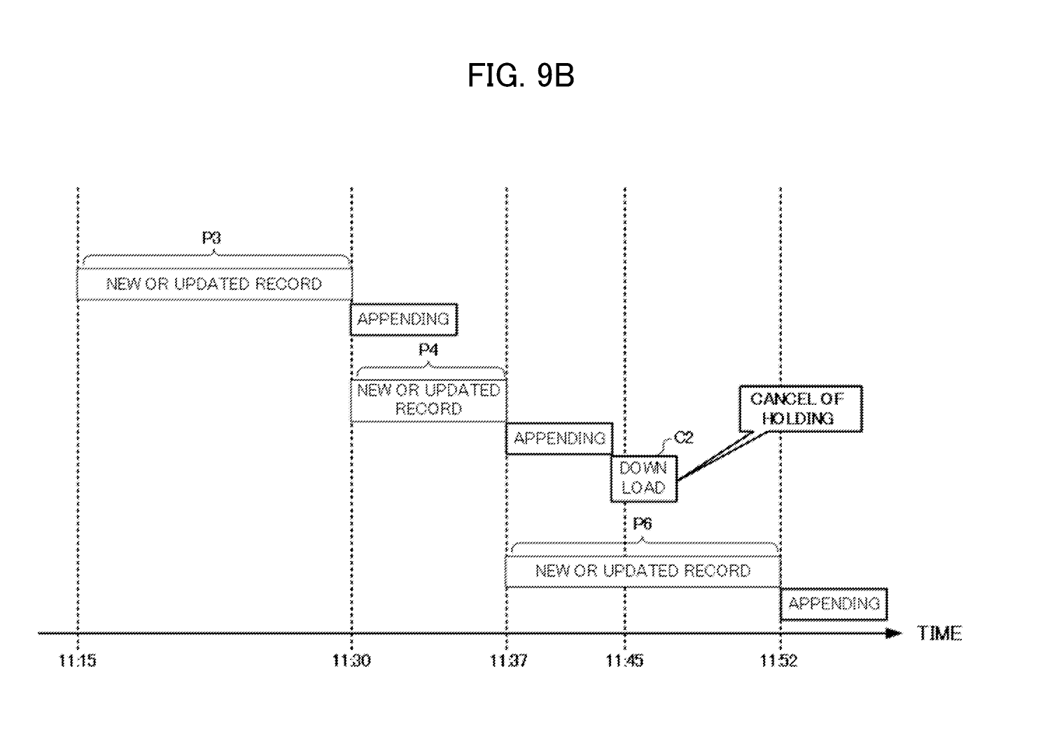

Returning to FIG. 3, when the above provider 270 completes provision of the report file RF to the store terminal 400, the resumer 280 initializes the report file RF, that is, deletes contents of the report file RF, and then cancels the holding of the intermittent appender 250 to cause the intermittent appender 250 to resume the appending. For example, the resumer 280 cancels the holding of the intermittent appender 250, and causes the intermittent appender 250 to resume the appending at the next timing of appending. When canceling the holding, the resumer 280 transmits to the intermittent appender 250 a time when the supplementary appender 260 has appended the log information. For example, as illustrated in FIG. 9A, upon completion of the download C2, the resumer 280 cancels the holding of the intermittent appender 250. Then, at 12:00 that is the first timing of appending after cancel of the holding, the intermittent appender 250 appends to the report file RF the log information of a record newly generated or updated during a period P5 from 11:37 to 12:00. Thereafter, the intermittent appender 250 appends the log information to the report file RF at each of subsequent timings of appending at 15-minute intervals. In the configuration in FIG. 9A, at the first timing of appending after cancel of the holding, the intermittent appender 250 appends to the report file RF the log information of the period P5 that is a longer period than 15 minutes, and the load may be thus higher than usual. Therefore, when the holding has been canceled, the timing of appending by the intermittent appender 250 may be adjusted as appropriate. For example, as illustrated in FIG. 9B, upon completion of the download C2, the resumer 280 cancels the holding of the intermittent appender 250. At this time, the resumer 280 transmits, to the intermittent appender 250, not only the time when the supplementary appender 260 has appended the log information at 11:37, but also the next timing of appending at 11:52. Then, at 11:52 that is the transmitted timing of appending, the intermittent appender 250 appends to the report file RF the log information of a record newly generated or updated during a period P6 from 11:37 to 11:52. Thereafter, the intermittent appender 250 appends the log information to the report file RF at each of subsequent timings of appending at 15-minute intervals.

The above CPU 501 can function as the resumer 280 as described above.

### Operations of Server Device According to Embodiment

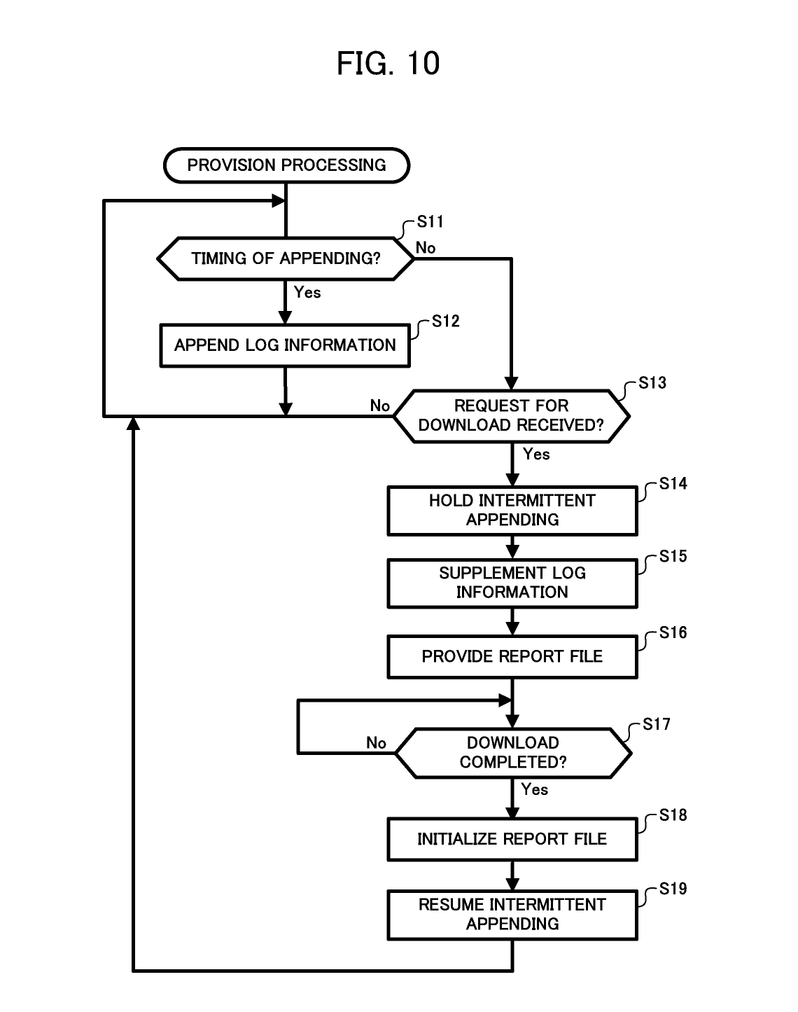

Hereinafter, operations of the server device 200 are described with reference to FIG. 10. FIG. 10 is a flowchart illustrating a flow of provision processing performed by the server device 200. This provision processing is performed, for example, in a separate process for each of the stores outsourcing the logistics operations. That is, the separate report file is prepared for each of the stores. The report file is initialized before start of the provision processing.

The server device 200 determines whether the timing of appending has arrived (step S11). When determining that the timing of appending has arrived (Yes in step S11), the server device 200 appends the log information (step S12). That is, the intermittent appender 250 searches for a record newly generated or updated after the previous timing of appending among the records associated with the store ID 211a in the product management information 211, and appends the log information of the searched record to the report file RF. For example, as illustrated in FIG. 6, the intermittent appender 250 appends to the report file RF the log information of the period P1 at 11:00, the log information of the period P2 at 11:15, and the log information of the period P3 at 11:30.

After appending the log information to the report file RF, the server device 200 returns the processing to the above step S11.

When determining that the timing of appending has not arrived (No in step S11), the server device 200 determines whether the request for download has been received (Step S13). That is, the server device 200 determines whether the request for download of the report file RF has been received from the store terminal 400.

When determining that the request for download has not been received (No in step S13), the server device 200 returns the processing to the above step S11.

When determining that the request for download has been received (Yes in step S13), the server device 200 holds intermittent appending (step S14). That is, the provider 270 causes the intermittent appender 250 to hold appending.

The server device 200 supplements the log information (step S15). That is, the supplementary appender 260 searches for a record newly generated or updated after the previous timing of appending by the intermittent appender 250 among the records associated with the store ID 211a in the product management information 211, and appends the log information of the searched record to the report file RF. For example, as illustrated in FIG. 7, upon receiving the request for download from the store terminal 400 at 11:37 after the intermittent appender 250 has appended the log information of the period P3, which is 11:15 to 11:30, to the report file RF at 11:30, the supplementary appender 260 appends to the report file RF the log information of a record newly generated or updated during the period P4 from 11:30 to 11:37.

The server device 200 provides the report file (step S16). That is, the provider 270 provides the requesting store terminal 400 with, that is, causes the requesting store terminal 400 to download, the report file RF supplemented with the log information in the above step S15.

The server device 200 determines whether the download has been completed (step S17), and while the download has not been completed (No in step S17), holds subsequent processing. When determining that the download has been completed (Yes in step S17), the server device 200 initializes the report file (step S18). That is, the resumer 280 deletes all of the log information stored in the report file RF.

The server device 200 resumes the intermittent appending (Step S19). The server device 200 then returns the processing to the above step S11. That is, the server device 200 returns the processing to the above step S11 to resume the intermittent appending. For example, as illustrated in FIG. 9A, upon completion of the download C2, the resumer 280 cancels the holding of the intermittent appender 250. At this time, the resumer 280 transmits to the intermittent appender 250 the time when the supplementary appender 260 has appended the log information at 11:37. Then, at 12:00 that is the first timing of appending after cancel of the holding (Yes in step S11), the intermittent appender 250 appends to the report file RF the log information of a record newly generated or updated during the period P5 from 11:37 to 12:00 (step S12). In addition, for example, as illustrated in FIG. 9B, upon completion of the download C2, the resumer 280 cancels the holding of the intermittent appender 250. At this time, the resumer 280 may transmit, to the intermittent appender 250, not only the time when the supplementary appender 260 has appended the log information at 11:37, but also the next timing of appending at 11:52. In this configuration, at 11:52 that is the transmitted timing of appending (Yes in step S11), the intermittent appender 250 appends to the report file RF the log information of a record newly generated or updated during the period P6 from 11:37 to 11:52 (step S12).

Through the provision processing as described above, most of the report file is generated in advance, and the report file can be thus provided immediately after receiving the request for download. This allows quick provision of the report file.

### Other Embodiments

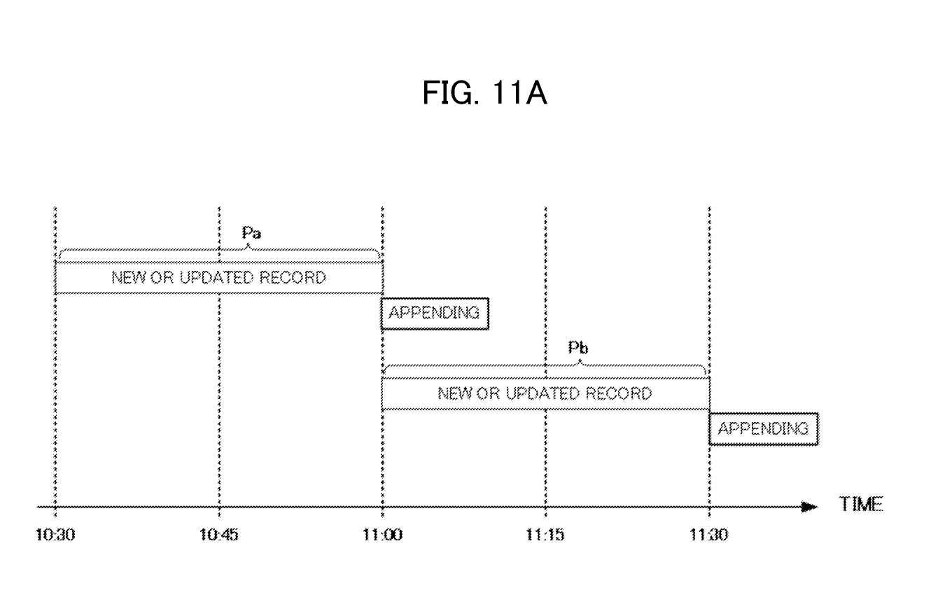

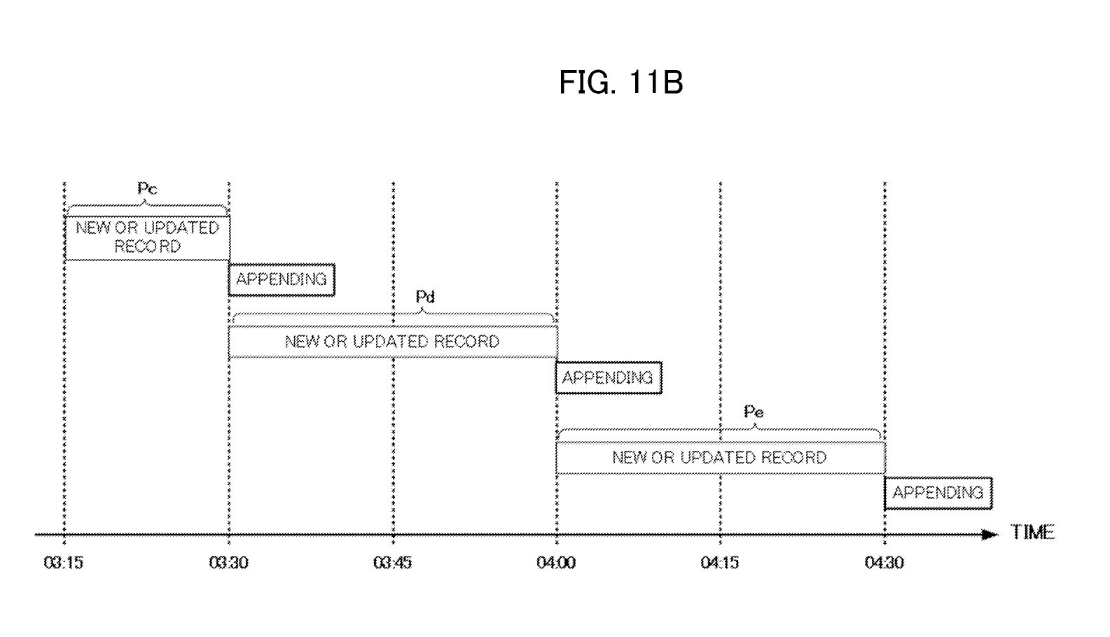

The above embodiment describes a configuration in which the intermittent appender 250 intermittently appends the log information to the report file RF at 15-minute intervals, but this is merely an example. The intermittent appender 250 may append the log information to the report file RF at other time intervals. In addition, the intermittent appender 250 may append the log information at different time intervals for each of the stores outsourcing the logistics operations in accordance with the quantity, sales frequency, or the like of products handled by the store. For example, when the quantity of products handled by one of the stores outsourcing the logistics operations is less than a certain quantity or when the sales frequency of the products is less than a certain frequency, the intermittent appender 250 appends the log information to the report file RF at 30-minute intervals, as illustrated in FIG. 11A.

Furthermore, the time intervals may be changed in accordance with time-of-day periods. For example, for a store with few sales during a time-of-day period from midnight to dawn, for example, from 03:30 am to 04:30 am, the intermittent appender 250 appends the log information to the report file RF at 30-minute intervals only during the time-of-day period from 03:30 am to 04:30 am, as illustrated in FIG. 11B. Before and after the above time-of-day period, the intermittent appender 250 appends the log information to the report file RF at 15-minute intervals.

The above embodiment describes a configuration in which the resumer 280 simply initializes the report file RF, but may initialize the report file RF after duplicating or copying the report file RF as a history file. The resumer 280 may also cause a newly-generated file with a different name to serve as the report file RF, that is, switch the report file RF to be appended. For example, the resumer 280 causes a file with a different name including the date and time when the supplementary appender 260 has performed appending to serve as the report file RF. That is, a configuration may be provided that allows appending of the log information after the above date and time to be grasped from a file name.

As described above, the present disclosure can provide a server device, a provision method, and a recording medium capable of quickly providing a report file.

1. A server device comprising:
an intermittent appender to intermittently append to a report file for a customer, at a predetermined time interval, log information of a record newly generated or updated in a database;
a supplementary appender to, upon receiving a request for download of the report file from a customer terminal used by the customer, append to the report file the log information after previous appending by the intermittent appender;
a provider to, upon start of appending by the supplementary appender, cause the intermittent appender to hold appending, and upon completion of the appending by the supplementary appender, provide the customer terminal with the report file; and
a resumer to, upon completion of providing the report file by the provider, initialize the report file, and then cancel holding of the intermittent appender to cause the intermittent appender to resume the appending.

2. The server device according to claim 1, wherein
the intermittent appender appends to the report file the log information after the previous appending or the log information after previous supplementing by the supplementary appender.

3. The server device according to claim 1, wherein
the intermittent appender and the supplementary appender append the log information processed into a predetermined format to the report file.

4. The server device according to claim 1, wherein
the resumer cancels the holding of the intermittent appender to cause the intermittent appender to resume the appending after duplicating the report file as a history file and then initializing the report file, or after causing a newly-generated file with a different name to serve as the report file.

5. A provision method to be executed by a server device, the provision method comprising:
an intermittent appending step of intermittently appending to a report file for a customer, at a predetermined time interval, log information of a record newly generated or updated in a database;
a supplementary appending step of, upon receiving a request for download of the report file from a customer terminal used by the customer, appending to the report file the log information after previous appending in the intermittent appending step;
a provision step of, upon start of appending in the supplementary appending step, holding appending in the intermittent appending step, and upon completion of the appending in the supplementary appending step, providing the customer terminal with the report file; and
a resuming step of, upon completion of providing the report file in the provision step, initializing the report file, and then canceling the holding to resume the appending in the intermittent appending step.

6. A non-transitory computer-readable recording medium storing a program, the program causing a computer to perform operations comprising:
an intermittent appending step of intermittently appending to a report file for a customer, at a predetermined time interval, log information of a record newly generated or updated in a database;
a supplementary appending step of, upon receiving a request for download of the report file from a customer terminal used by the customer, appending to the report file the log information after previous appending in the intermittent appending step;
a provision step of, upon start of appending in the supplementary appending step, holding appending in the intermittent appending step, and upon completion of the appending in the supplementary appending step, providing the customer terminal with the report file; and
a resuming step of, upon completion of providing the report file in the provision step, initializing the report file, and then canceling the holding to resume the appending in the intermittent appending step.
